(19) United States
(12) Patent Application Publication
(10) Pub. No.: US 2024/0351832 A1
(43) Pub. Date: Oct. 24, 2024

(54) PULLEY ASSEMBLY

(71) Applicant: TREEMAGINEERS LTD, Pitlochry (GB)

(72) Inventors: Christopher COWELL, Pitlochry (GB); John Rhys LLOYD, Oberösterreich (AT); Elliot TANNER, Montgomery (GB)

(21) Appl. No.: 18/686,821

(22) PCT Filed: Aug. 19, 2022
(86) PCT No.: PCT/EP2022/073209

§ 371 Date: Feb. 26, 2024

(30) Foreign Application Priority Data
Aug. 27, 2021 (GB) 2112273.4

(51) Int. Cl. B66D 3/08; B66C 21/08

(52) U.S. Cl. CPC B66D 3/08; B66C 21/08; B66C 2700/011

(57) ABSTRACT

A pulley assembly and an installation for moving objects incorporating such a pulley assembly are disclosed. The pulley includes first and second plates disposed about a median plane. One or more sheaves are disposed between the plates. The or each sheave is carried for rotation about a respective sheave axis that is perpendicular to the median plane. A bollard extends between the plates to provides an interconnection between the plates. The bollard is shaped, whereby its dimension in a direction along a major dimension line, which dimension line that extends radially from one of the sheave axes, is greater than its dimension in a direction perpendicular to that dimension line.

### CROSS-REFERENCE TO RELATED APPLICATIONS

This application is the US national stage of PCT/EP2022/073209, filed Aug. 19, 2022 and designating the United States, which claims the priority of GB 2112273.4, filed Aug. 27, 2021. The entire contents of each foregoing application are incorporated herein by reference.

### BACKGROUND OF THE INVENTION

### Field of the Invention

This invention relates to a pulley assembly. In particular, it relates to a type of rope pulley assembly commonly known as a “redirect” or “organiser block”.

### Description of the Related Art

Trolleys, ropes and pulleys are used to build systems that can lift a load and transport it along a main rope between distant points, often at height spanning obstacles in terrain, such as rivers or gorges that might significantly obstruct ground-borne transport Such systems may find application in forestry, to carry tools and people to a work site and to remove felled timber. They may also find application in large, remote construction sites, such dams, to deliver materials to the location where they are needed, or to remove waste materials from where they are not desired. They can also be used to extract an injured person from a site that has restricted access.

To enable a trolley to work effectively, the ropes that it runs along and is controlled by must be precisely tensioned and managed. As a main line upon which a trolley is carried may often be installed out of reach of an operator, often at great height, redirect devices are employed to bring some or all the installed ropes to a position where they can be conveniently accessed. In this way, the load lines can be tensioned with greater ease and the control lines can be operated efficiently.

### SUMMARY OF THE INVENTION

From a first aspect, this invention provides a pulley assembly comprising:
first and second plates disposed about a median plane;
one or more sheaves disposed between the plates, the or each sheave being carried for rotation about a respective sheave axis that is perpendicular to the median plane;
a bollard that extends between the plates that provides an interconnection between the plates; wherein
the bollard is shaped, whereby its dimension (size/extent) in a direction along a major dimension line, which dimension line extends radially from one of the sheave axes is greater than its dimension in a direction perpendicular to that dimension line.

The bollard is typically used to secure the pulley assembly to a fixed anchor. By making the bollard more extensive in the major dimension line that extends radially from a sheave axis, the tendency of the pulley assembly to pivot about the bollard is inhibited. This enhances the ability of a user to control movement of ropes guided by the pulley assembly.

Preferred embodiments include a plurality of sheaves. The sheaves may be of the same size, or they may be of different sizes (that is, working diameters). For example, the sheaves may decrease in size with increasing distance from the bollard.

In embodiments that include a plurality of sheaves, the major dimension line may extend through the sheave axis of each of a plurality of sheaves (e.g., of all of the sheaves).

The pulley assembly may include a cross-hole that extends generally perpendicular to the median plane through the plates and through the bollard. The cross-hole may be used as a second back-up anchor for the pulley assembly.

The dimension of the bollard in a direction along a major dimension line that extends radially from a sheave axis is typically greater than its dimension in a direction perpendicular to that line by a factor f of 2 or more. For example, the factor f≃3 (e.g., 3 to within 1 d.p.).

The bollard may provide a solid and immovable interconnection between the plates. Alternatively, the bollard may be releasably connected to one or both of the plates. The later arrangement allows the plates to be separated, for example by pivoting, or it may allow the bollard to be removed to allow insertion or removal of a rope.

In preferred embodiments, the pulley assembly is symmetrical, or approximately symmetrical, about the median plane. A symmetrical embodiment may require fewer distinct components than an asymmetrical one.

From a second aspect, this invention provides an installation for moving objects comprising a main line secured to two spaced-apart anchors; a trolley supported by and capable of moving along the main line; a control line connected to the trolley, whereby tension on the control line can draw the trolley along the main line; and a pulley assembly embodying the first aspect of the invention; wherein the pulley assembly is connected to an anchor by a line that is passed about the bollard, and the control line extends over one of the sheaves of the pulley assembly.

The shape of the bollard tends to pull the pulley assembly into a steady alignment where the major dimension of the bollard approaches the direction of force that passes through the pulley assembly. This is in contrast with a conventional pulley assembly that is employed in such an installation in which the alignment of the pulley assembly is unconstrained and is determined by its weight and the direction and magnitude of the forces acting on the pulley assembly through the main and control lines.

In an installation embodying the invention may further include a lifting line that is secured to a load to be moved, and that extends over a sheave of the trolley and a sheave of the pulley assembly, and has a free end portion that extends from the pulley assembly. An installation embodying the invention may further include a securing line, a length of which passes in a bight around the bollard and which is secured to an anchorage.

Embodiments in which the pulley assembly includes a cross-hole may further include a secondary securing line that passes through the cross-hole and is secured to an anchorage. Alternatively or additionally, one securing line may be passed around an anchorage multiple times and through the cross hole and around the bollard.

### BRIEF DESCRIPTION OF THE DRAWINGS

An embodiment of the invention will now be described in detail, by way of example, and with reference to the accompanying drawings, in which:

FIGS. 1, 2 and 3 are views of a pulley assembly being a first embodiment of the invention;

FIG. 4 is a cross-section of the pulley assembly of FIGS. 1 to 3;

FIG. 5 is an exploded view of the pulley assembly of FIGS. 1 to 3;

FIGS. 6 and 7 are detailed and cross-sectional views of a bollard arrangement of the pulley assembly of FIGS. 1 to 3;

FIG. 8 shows half of a bollard arrangement of the pulley assembly of FIGS. 1 to 3;

FIG. 9 shows in detail a secondary cross hole in the bollard arrangement of the pulley assembly of FIGS. 1 to 3;

FIG. 10 shows an embodiment of the invention installed as a component of a rigging installation;

FIG. 11 shows, diagrammatically, a first rigging installation that incorporates a pulley assembly embodying the invention;

FIG. 12 shows, diagrammatically, a second rigging installation that incorporates pulley assemblies embodying the invention;

FIG. 13 shows the installation of FIG. 12 in an alternative configuration;

FIG. 14 shows a lifting and/or tensioning installation that incorporates pulley assemblies embodying the invention;

FIG. 15 shows an arrangement similar to that of FIG. 14 used as a tensioning installation;

FIG. 16 shows diagrammatically ropes passing over two adjacent sheaves in an embodiment of the invention;

FIG. 17 shows diagrammatically an alternative arrangement for anchoring a pulley embodying the invention in a rigging installation;

FIG. 18 shows in detail an alternative bollard arrangement of an embodiment of the invention; and

FIG. 19 shows an embodiment of the invention that includes a single sheave.

### DETAILED DESCRIPTION

With reference to the drawings, a pulley assembly comprises first and second plates 10, 12. The plates are almost identical, so features of the first plate 10 will be described, and these should be assumed to be present also in the second plate 12. Where there are differences between the plates 10, 12, these will be described specifically. Each plate 10, 12 has an inner and an outer surface, the plates 10, 12 being disposed with their inner surfaces facing one another symmetrically on opposite sides of a median plane M.

The peripheral shape of the plates 10, 12 is not critical to the operation of the invention. Plates that are a simple rectangular shape would work as effectively. The particular peripheral shape of this embodiment is chosen to extend beyond components located between the plates 10, 12 by minimal amount, thereby saving weight as compared with rectangular plates and also to ensure efficient fairlead of ropes on to the sheaves. Further weight is saved by formation of recesses 14 into outer surfaces of the plates, the weight of the material that would otherwise occupy the recesses 14 thereby being saved. These recesses 14 also provide suitable locations for application of product markings (which are essential for identification and to meet compliance requirements) because such location offers protection of the markings from wear and abrasion.

The pulley assembly further includes sheave assemblies and a bollard arranged along a common axis A that extends between the plates 10, 12. These will all be described below.

In this embodiment, there are three sheave assemblies. These are similar to one another with the exception that each of them includes a sheave, the sheaves 20′, 20″, 20″ being of successively lesser outer diameter as their distance from the bollard increases. The outer diameters of the three sheaves 20 are different from one another in this embodiment, but otherwise the sheave assemblies are substantially similar. Typically, the differences in diameter between adjacent sheaves 20 is greater than the diameter of a line or lines with which the pulley assembly is intended or approved for use-for example, the difference may be greater than twice the 2× diameter of a line or lines with which the pulley assembly is intended or approved for use. Thus, the offset between adjacent tread diameters is greater than the maximum approved rope diameter.

Each sheave assembly includes a sheave (referred to generically as 20) that is carried on a pair of rolling bearings 22 that are supported by an axle bolt 24. Each sheave 20 has a peripheral outer surface centred on a respective sheave axis, which outer surface is shaped and dimensioned to allow a suitable line (typically rope or cable) to run upon it when the pulley assembly is in use. A bore 26 extends axially though the sheave 20, the bore 26 being generally cylindrical, with a rib 27 inwardly extending into it from the periphery of the bore 26 at its centre. The sheave axes are in this and many other embodiments parallel and spaced apart along a common axis (typically a rectilinear axis) such as the common axis A.

Each roller bearing 22 is retained within the bore 26, being inserted into the bore from opposite ends of the bore 26 with a spacer 28 between them. The bore 26 and the bearings 22 are sized such that the outer race of the bearings 22 is a close fit within the bore 26 and such that the extent to which the bearings 22 can be inserted is limited by the rib 27.

Each axle bolt 24 has a cylindrical shaft 30 and a head 32, (indicated in FIG. 4). A tapped bore extends into the shaft 30 from its free end (the opposite end from the head 32). The shaft has an external diameter such that it is a close fit within the inner race of the bearings 22.

The head 32 has a peripheral shape that is predominantly circular, which a flattened section and an arcuate notch formed into it, the flattened section and notch being diametrically opposite one another.

Each sheave assembly further includes a securing bolt 36. The securing bolt 36 has a threaded shaft and a head of circular section. A peripheral groove is formed in the head, there being an elastomeric O-ring 38 located in the groove.

Each plate 10, 12 has three through holes 40, which will be referred to as “sheave axle holes”, each of which is associated with a respective one of the sheave assemblies. Each sheave axle hole 40 opens on the inner and the outer surfaces of the plates 10, 12. In each case, a part of the sheave axle hole 40 closest to the inner surface is of circular cross-section, and of diameter such that the shafts 30 of the axle bolts 24 are a close fit within it. At the outer surface, each sheave axle hole 40 is surrounded by a recess 42. In the first plate 10, each recess 42 is circular, with a flattened, inwardly displaced section, diametrically opposite which is an arcuate, outwardly extending notch. A tapped hole is formed in the notch. In the second plate 12, the portion of the axle hole 40 nearest the outer surface is formed with a simple counterbore.

Each sheave assembly is completed by inserting two bearings 22 into opposite ends of the bore 26 as far as the rib 27 will allow, with the spacer 28 being placed between them, in contact with inner races of the bearings 22. An axle bolt 24 is then passed through one of the axle holes 40 in the first plate 10, through the inner races of the bearings 22 and into the corresponding axle hole 40 of the second plate 12. The head 32 of the axle bolt 24 is received in the recess 42, the flattened portions of the recess 42 and the head 32 interengaging to prevent rotation of the axle bolt 24 within the axle hole 40. A retention bolt 44 has a shaft that is screwed into the tapped hole in the recess 42, its head making contact with the head 32 of the axle bolt 24 to prevent rotation and sliding removal of the axle bolt 24.

The shaft of a securing bolt 36 is then passed through the axle hole 40 of the second plate 12 and screwed into the tapped bore of the axle bolt 24, and tightened to clamp the bearings 22 and spacer 28 between the plates. The O-ring 38 is compressed against the counterbored part of the axle hole 40 in the second plate 12 to resist rotation and consequential loosening of the securing bolt 36.

The bollard includes a bollard block 50. The bollard block 50 has a peripheral surface 52 that is concave in cross-section to act as a guide to urge a rope or other line upon it towards the median plane M. The bollard block 50 has a peripheral shape that has parallel sides interconnected by semi-circular end portions. Parallel, spaced, flat mating surfaces extend from the periphery of the bollard block towards a central aperture 54 that extends through the bollard block 50 perpendicular to the median plane M. Bosses 60 surrounds the central aperture 54 and project from each of the mating surfaces, the bosses 60 having a peripheral shape that has two parallel long sides interconnected by semi-circular end portions. Two tapped and counterbored through-bores 58 are formed into the bollard block 50 adjacent to the boss 60. Each plate 10, 12 has a through-hole 62 that corresponds in shape and size to the bosses 60, such that each boss 60 is a close fit within the through-hole 62. A recess 64 is formed in the inner surface of each plate 10, 12 surrounding the through-hole 62. Two bolt holes 66 are formed through each plate 10, 12, the holes being countersunk at the outer surfaces of the plates 10, 12. A bolt hole boss 68 surrounds each bolt hole 66 at the inner surfaces.

The bollard is assembled by passing the shank of a countersunk machine screw 70 through each bolt hole 66 to be received in opposite ends of the tapped bores 58. As the machine screws 70 are tightened, each boss 60 is received within a corresponding through-hole 62 of the plates 10, 12; the bolt hole bosses 68 are received within the counterbores of the tapped bores 58; and the mating surfaces of the bollard block 50 are clamped against the plates 10, 12 within the recesses 64. The respective shapes and sizes of the recesses 64 and the periphery of the bollard block 50, the bosses 60, 68 and counterbores are such that they are in a close fit to locate the bollard block 50 accurately in position on the plates 10, 12. Once the screws 70 are tightened, the bollard block 50 provides a solid and rigid interconnection between the plates 10, 12 to constitute a bollard for the pulley assembly. The central aperture 54 aligns with the through holes 62 to form a cross-hole that extends transversely through the pulley assembly.

The bollard is arranged to be longer in the direction of a major dimension line than in a perpendicular minor dimension line. In this embodiment, the major dimension line passes through the centre axes of the tapped through-bores 58, which means that it is coincident with the common axis A. Therefore, the bollard has a greater dimension along the common axis A than it has in the opposite direction. In this example, the bollard has dimensions of 83 mm along the common axis A and 28 mm in a transverse direction (line B), giving a ratio r of the lengths is approximately 3:1 (r=2.96 to 2 decimal places). This may vary in other embodiments, for example 3.1:1. A guide range might 3:1±10%,:1±20%, or otherwise.

The central aperture 54 of the bollard is flared where it exits to the outer surfaces of the plates 10, 12 to present a convex surface with generous bend radius over which a rope can pass without excessive friction or abrasion. The flare has a greater radius along the common axis A in a direction away from the sheaves. This tends to centre a line passing through the central aperture 54 that is tensioned with a component of force that is directed along the common axis A in a direction away from the sheaves.

In this embodiment, the bollard is formed by a solid, one-piece bollard component 52. An alternative arrangement includes two spaced cylindrical components disposed between the plates 10, 12 with centres spaced along the common axis A. As a further alternative, the bollard 130 may be formed integrally with the plates 132, 134, as shown in FIG. 18.

The plates 10, 12 further include secondary attachment holes 80 centred on the common axis A. These attachment holes can provide a connection point to which additional components can be connected. In this embodiment, the secondary attachment holes 80 are used to receive a removable pip pin 82 upon which a spacer 84 is carried between the plates 132, 134.

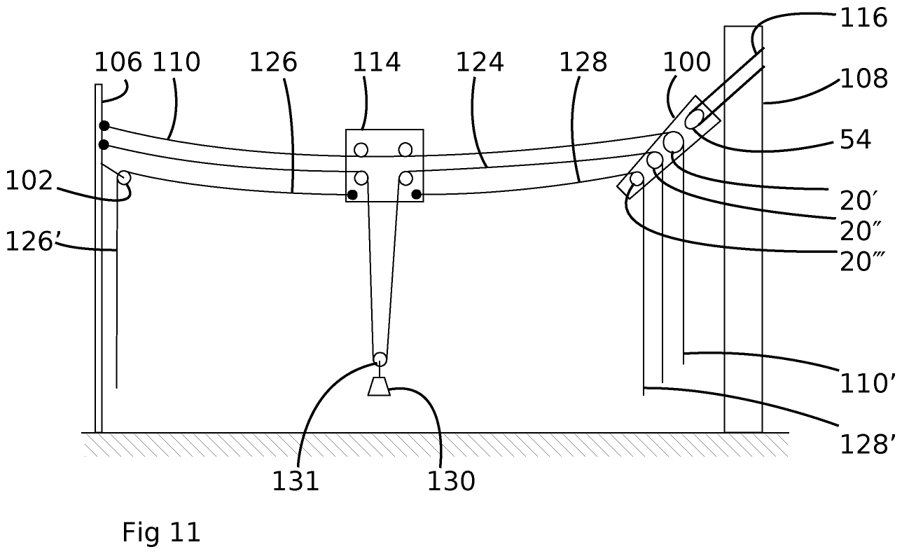

As shown in FIGS. 10 and 11, a pulley assembly 100 embodying the invention can be installed as a component of an installation for moving objects, typically of a type known as a “Tyrolean traverse” or a “skyline”.

The installation includes a main line 110 that extends between first and second spaced anchorages 106, 108 to span a void. A carriage 114 is carried on the main line 110, the carriage 114 having sheaves that make contact with the main line 110 to allow the carriage 114 to move along the main line 110. Examples of suitable carriages are disclosed in GB-A-2543561 and GB-A-2571193 of the present applicant, the content of which is incorporated herein by reference. The pulley assembly 100 is secured to the second anchorage 108 by way of a securing line 116 that passes around the second anchorage 108 and is passed around the bollard of the pulley assembly 100. An optional secondary securing line 118 passes around the second anchorage 108 and through the central aperture 54 of the pulley assembly which serves as redundancy in the event of failure of the securing line 116. The main line 110 is fixed to the first anchorage 106 and extends from it to pass over the largest sheave 20′ of the pulley assembly 100, from which a free end length 110′ of the main line 110 descends. The free end length 110′ may be secured to an anchorage during normal use.

The installation further includes first and second control lines 126, 128. The first control line 126 is fixed to an anchoring point on the carriage 114, from which it extends to a pulley 102 that is fixed to the first anchorage 106. A free end length 126′ of the first control line 126 extends downwardly from the pulley 102. The second control line 128 is fixed to an anchoring point on the carriage 114, from which it extends to pass over the smallest of the sheaves 20″ of the pulley assembly 100, and has a free end 128′ that extends downwardly from the pulley assembly 100. In addition, the installation includes a lifting line 124. The lifting line 124 extends from the first anchorage 106 through the carriage 114, where it passes over two sheaves, and thence to the pulley assembly 100, where it passes over the second-largest of the sheaves 20″. A free end 124′ of the lifting line 124 extends downwardly from the pulley assembly 100. A downwardly-extending bight is formed in the lifting line 124 between the sheaves of the carriage. A load 130 can be carried on the bight, typically being connected to the lifting line through a pulley 131. The free end 110′ of the main line 110 can be reduced or increased in length by drawing it over the sheave 20′ to increase or reduce the tension in the main line 110.

The carriage 114 can be caused to travel along the main line by a user pulling down on the free end 126′, 128′ of one or other control line 126, 128. The load 130 can be raised or lowered by a user pulling upon or releasing the free end 124′ of the lifting line. Unconstrained movement of the pulley assembly 100 can compromise accurate control of movement of the carriage 114 and the load, and it will be seen that variation in tension in the control lines 126, 128 and the lifting line 124 will tend to cause the pulley assembly 100 to move vertically and also to pivot about its bollard. The configuration of the bollard in embodiments of this invention tends to inhibit pivoting movement so improves both the precision of control that a user can exercise over movement of the load 130 and the carriage 114. Additionally, loads can be moved more efficiently as less effort is lost to a pivoting pulley. Specifically, if a bight is formed in the securing line 116 to surround the bollard, tension in the securing line will cause lengths of the securing line 116 to bear against long sides of the bollard, and thereby tend to urge the bollard into alignment with the securing line. The tendency of the pulley assembly 100 to pivot about the bollard is thereby reduced thereby improving efficiency and precision with which the load can be lifted and relocated.

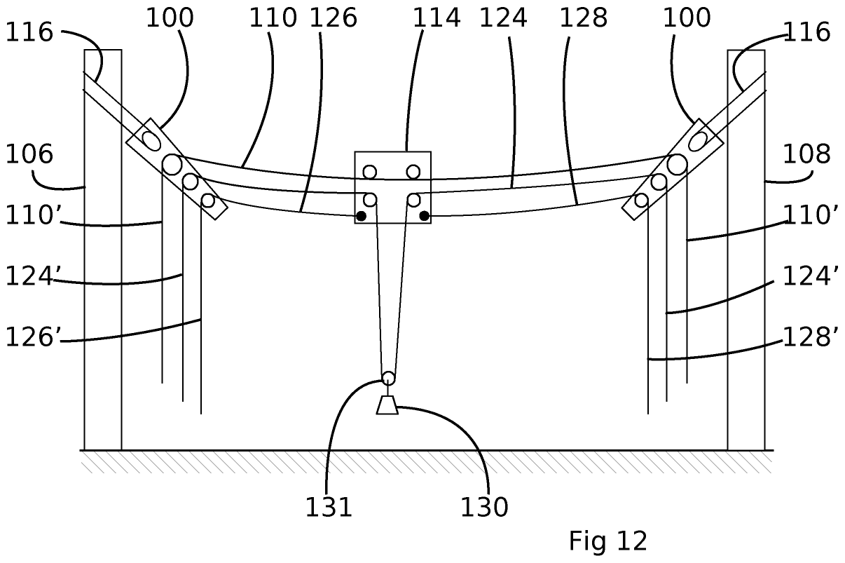

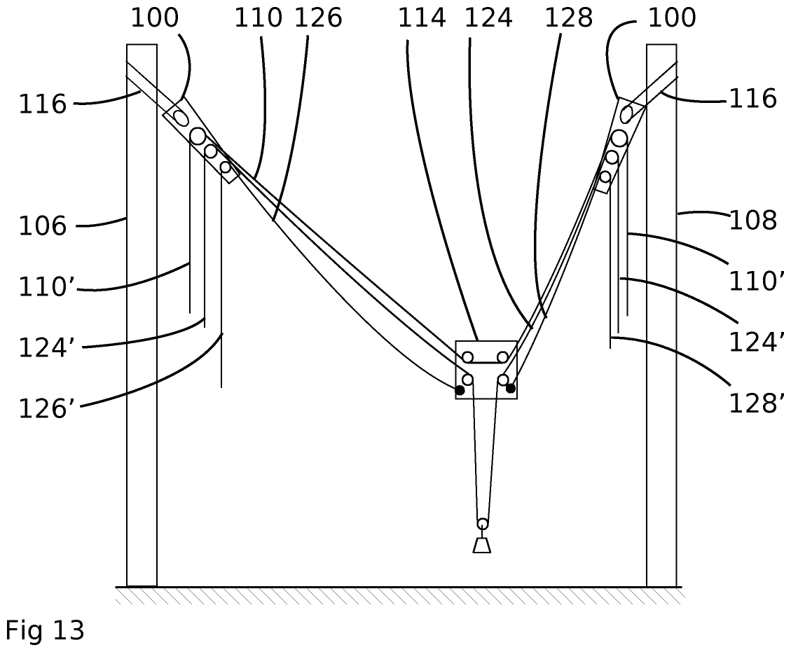

FIGS. 12 and 13 show an installation that is a modification of that of FIGS. 10 and 11. This embodiment is symmetrical, with a pulley assembly 100 embodying the invention being provided at both the first and second anchorages 106, 108. In this embodiment, control can be effected over the main line 110 and the lifting line 124 at both sides of the void.

FIG. 13 shows the effect upon the installation of reducing the tension in the main line 110. The main line 110, lifting line 124 and the control lines 126, 128 are closer to one another, but the differences in sizes between the sheaves 20′, 20″, 20″′ in the pulley assemblies 100 ensure that the lines remain spaced apart and do not interfere with one another.

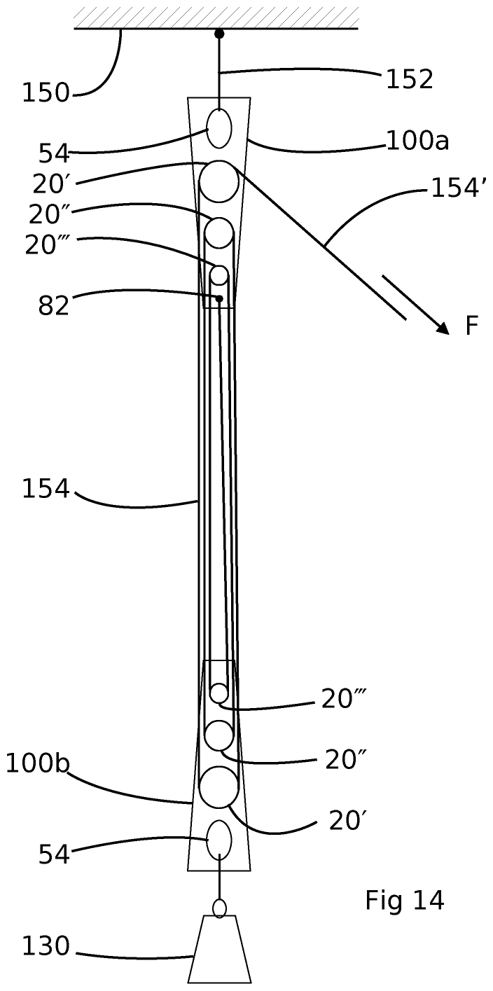

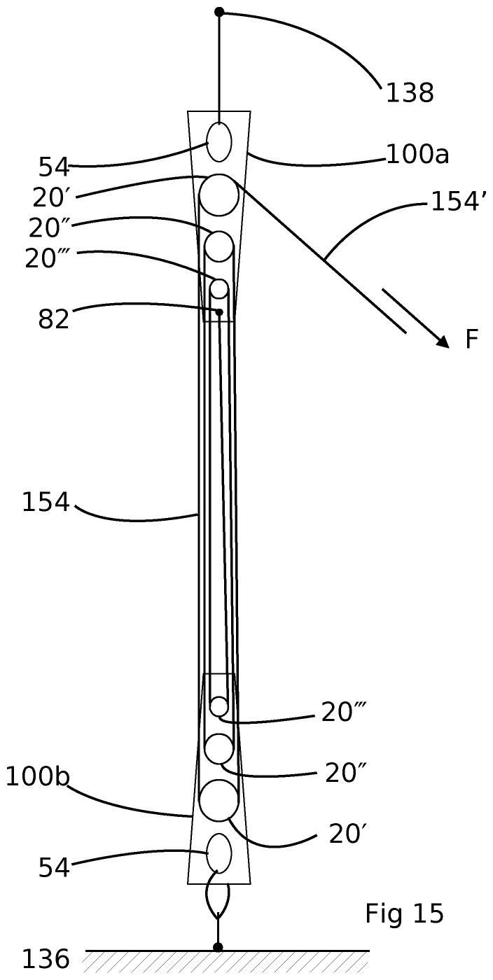

The installation of FIG. 14 uses upper and lower pulley assemblies 100a, 100b embodying the invention to provide a lifting or tensioning mechanism that offers a mechanical advantage over a load 130. The upper pulley assembly 100a is secured to an anchorage 150 by a securing line 152 passing through the central aperture 54 or around the bollard, its common axis A being approximately vertical and the largest sheave 20′ uppermost. The lower pulley assembly 100b is located below the upper pulley assembly 100a, its common axis A being approximately vertical and the smallest sheave 20″ uppermost. A lifting line 154 has a first end anchored by the pip pin 82 of the upper pulley assembly 100a and extends around the sheaves 20′, 20″, 20″′ of the lower and then the upper pulley assembly in order of increasing diameter. A free end of the lifting line 154′ extends from the largest sheave 20′ of the upper pulley assembly 100a. The effect of this installation is that a force of magnitude F applied to the free end 154′ applies a theoretical lifting force of magnitude 6F to be applied to the load.

A similar installation can be installed between a fixed anchor 136 and a load 138. In this arrangement, a force of magnitude F applied to the free end 154′ applies a tensioning force with a theoretical maximum magnitude of 7F. For example, this arrangement may be used connected to a fixed anchor such as a vehicle, tree or building, amongst many others, to apply tension to an object such as a stuck vehicle, part of a tree being felled, or a heavy item that is to be dragged or supported.

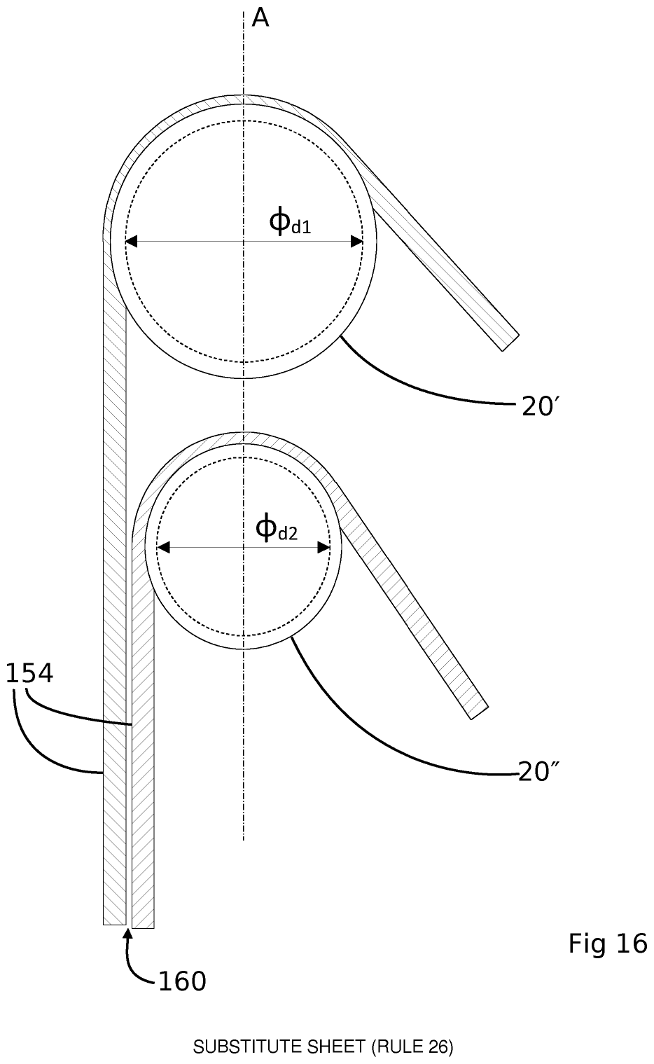

It will be seen that lengths of the lifting line 154 leave the pulley assemblies almost parallel to one another. The effect of the successive increase in diameters of adjacent sheaves 20′, 20″, 20″′ is that adjacent lengths of line leaving the pulley assemblies 100 are spaced apart and do not rub against one another, so reducing friction and wear. As shown in more detail in FIG. 16, each sheave 20′, 20″ has a tread diameter, indicated at ϕ_{d}, at which a line makes contact with the material of the sheave. The adjacent sheaves 20′, 20″ are chosen such that the differences between their tread diameters ϕ_{d1}-ϕ_{d2} is greater than twice the diameter of the line 154 used with the pulley assembly. This ensures that there is a clearance between adjacent runs of line 154, as shown at 160.

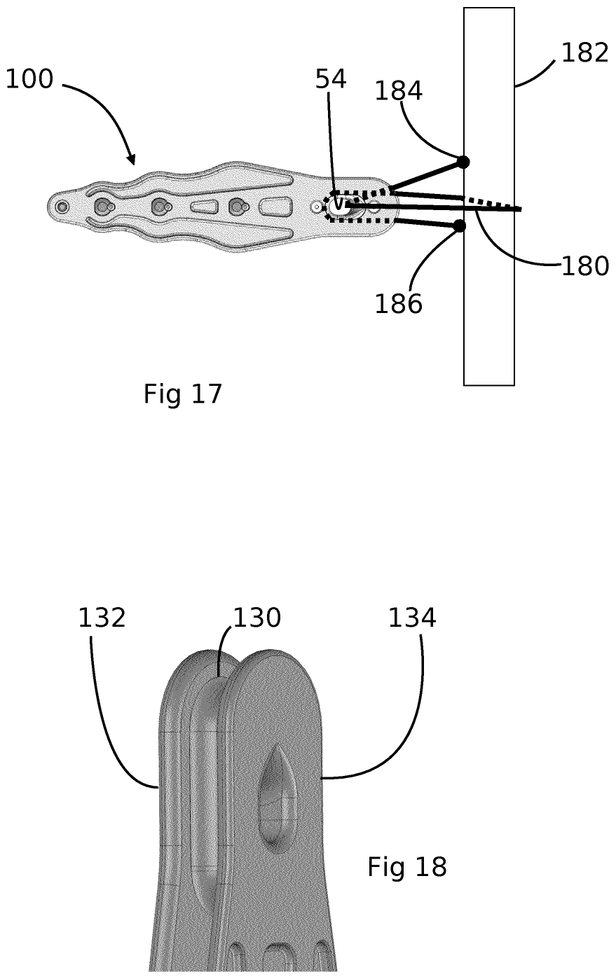

In the installation described above, a pulley assembly 100 embodying the invention is secured to an anchorage using two securing lines that act in parallel thereby providing redundancy should one of those lines fail. An alternative arrangement is shown in FIG. 17 which is potentially capable of withstanding greater loading (using the same type of securing line) with the downside that it does not offer redundancy. In this arrangement, a single securing line 180 is secured to an anchorage 182 at a first, fixed securing point 184. From the first securing point 184, the securing line 180 passes through the central aperture 54, from which it passes back around the anchorage 182 and then returns to the bollard of the pulley assembly 100. From the bollard, the securing line 180 basses back to the anchorage 182, where it is secured at a second securing point 186. The securing line 180 can slide over the bollard, can slide through the central aperture 54, and can also slide over the anchorage 182 where it passes between the central aperture 54 and the bollard.

It will be seen that there are four lengths of securing line 180 extending between the pulley assembly 100 and the anchorage 182, which can provide a loading strength up to twice that provided by a single loop of securing line. The ability of the securing line 180 to slide on the anchorage 182 and on the bollard and central aperture 54 allows pivoting movement to take place between the pulley assembly 100 and the anchorage 182 while maintaining approximately equal tension in the four lengths of the securing line, so equalising loading in the installation.

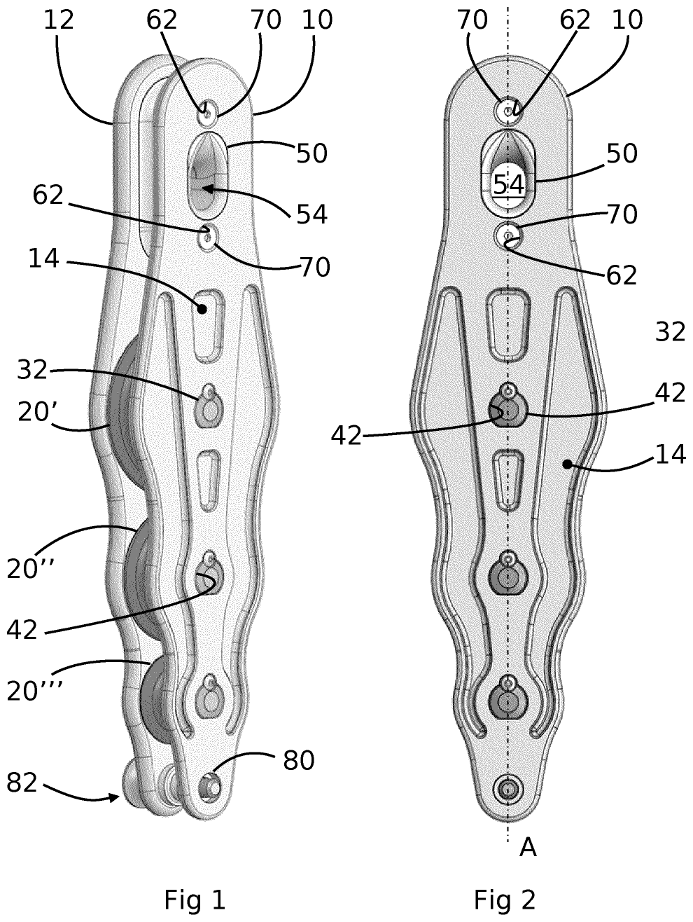

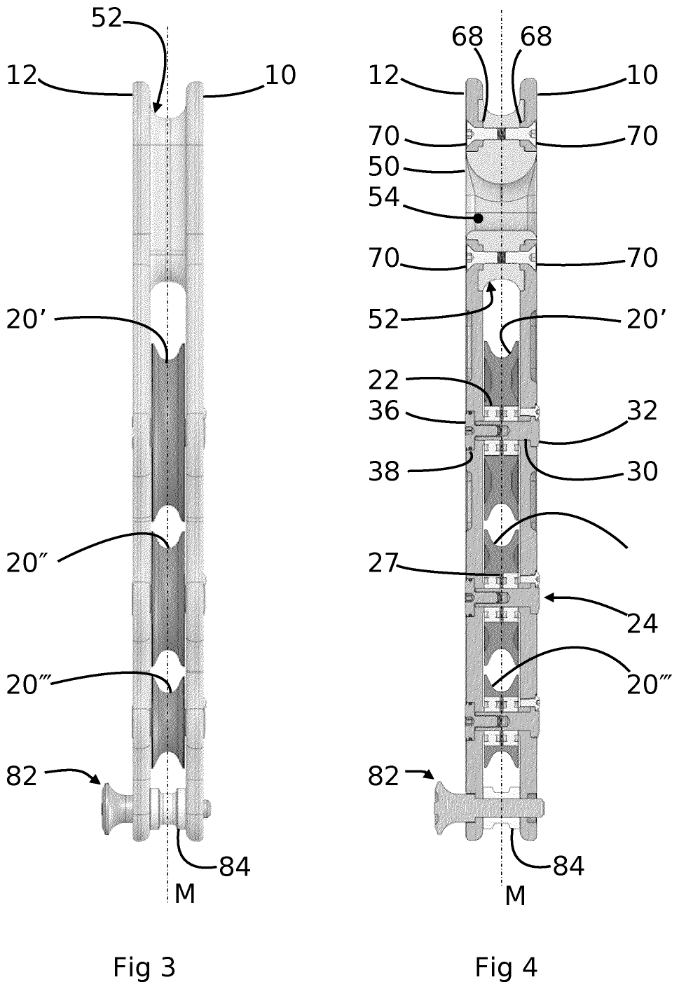

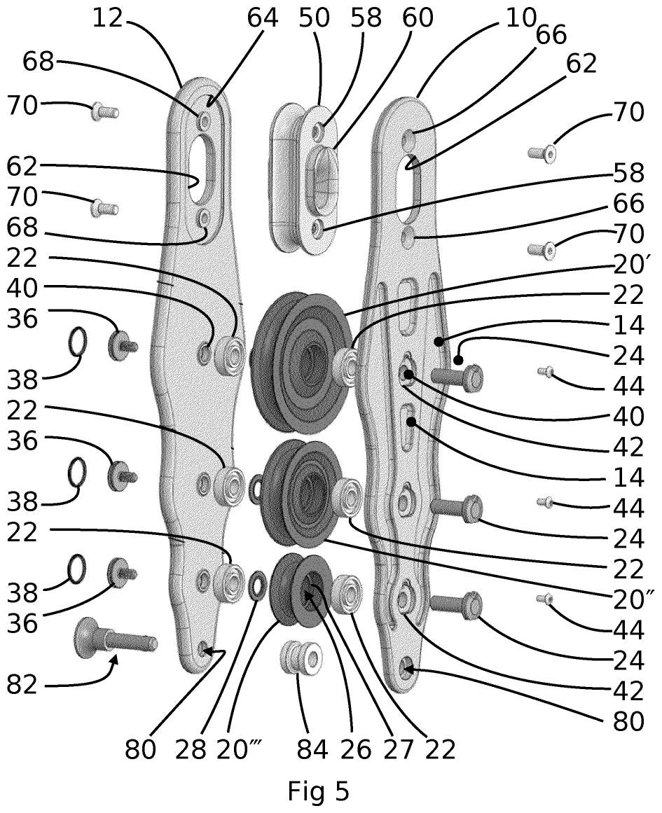

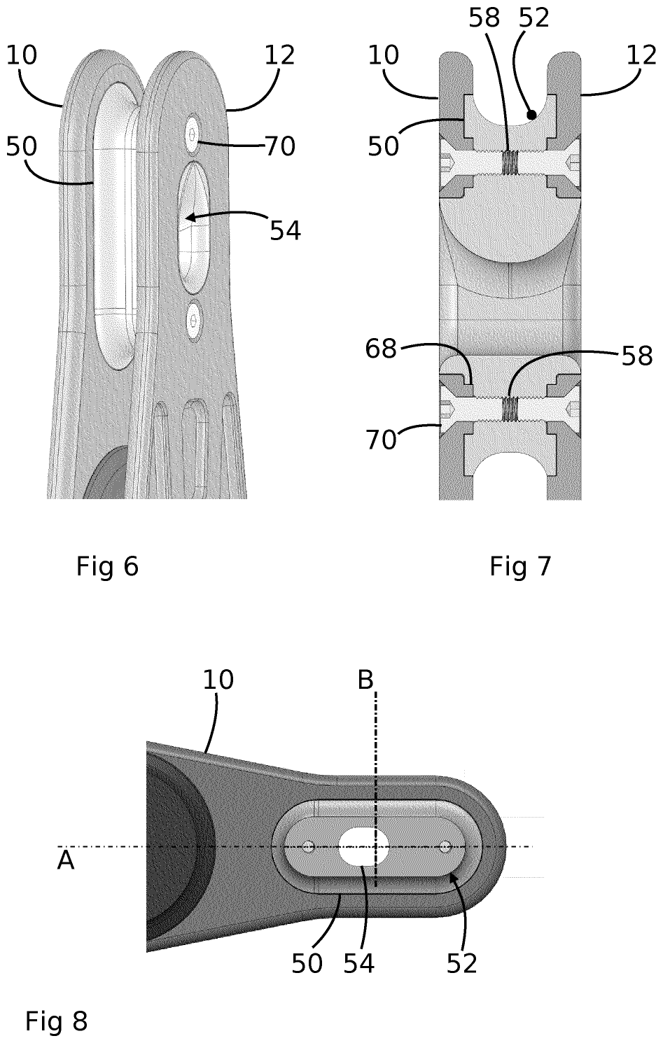

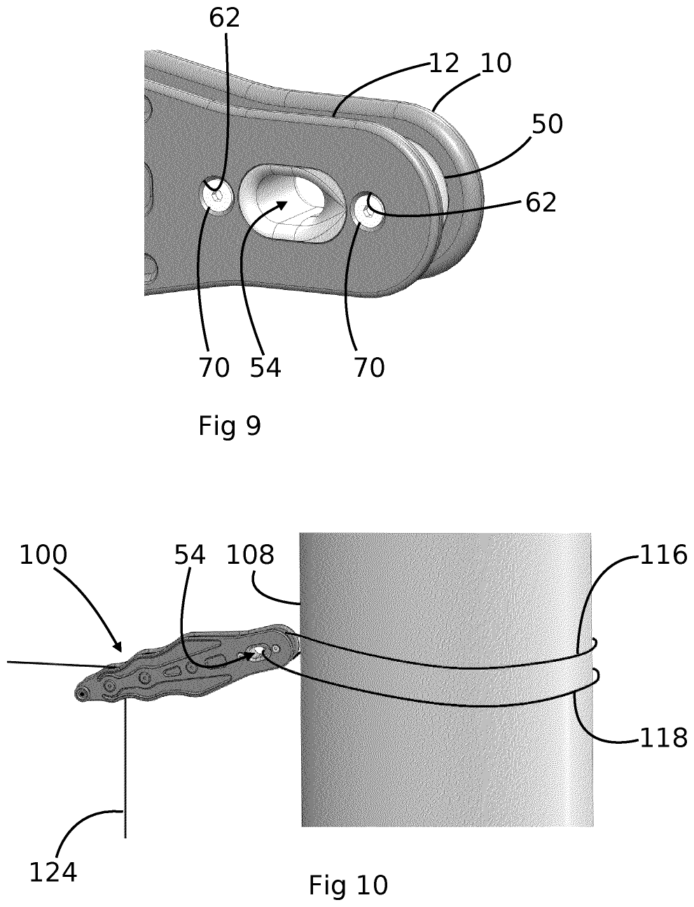

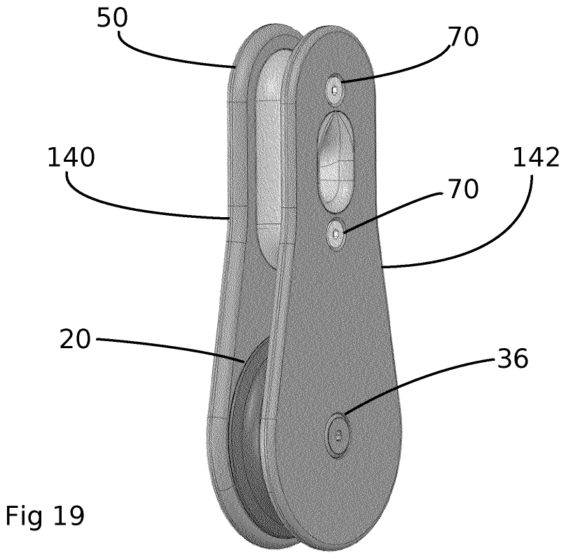

The embodiment of a pulley assembly shown in FIG. 19 has a construction that is substantially the same as that of FIGS. 1 to 9, with the exception that it includes a single sheave assembly.

1. A pulley assembly comprising:
a. first and second plates disposed about a median plane;
b. one or more sheaves disposed between the plates, the or each sheave being carried for rotation about a sheave axis that is perpendicular to the median plane;
c. a bollard that extends between the plates that provides an interconnection between the plates; wherein
d. the bollard is shaped, whereby its dimension in a direction along a major dimension line that extends radially from a sheave axis is greater than its dimension in a direction perpendicular to that line.

2. The pulley assembly of claim 1 which includes a plurality of sheaves.

3. The pulley assembly of claim 1 in which the sheaves are of the same size.

4. The pulley assembly of claim 1 in which the sheaves are of different sizes.

5. The pulley assembly of claim 4 in which the sheaves decrease in size with increasing distance from the bollard.

6. The pulley assembly of claim 2 in which the major dimension line extends through the sheave axis of each of a plurality of sheaves.

7. The pulley assembly of claim 6 in which the major dimension line extends through all of the sheaves.

8. The pulley assembly of claim 1 in which the pulley assembly includes a cross-hole that extends generally perpendicular to the median plane through the plates and through the bollard.

9. The pulley assembly of claim 1 in which the dimension of the bollard in a direction along a major dimension line that extends radially from a sheave axis is greater than its dimension in a direction perpendicular to that line by a ratio r of 2 or more.

10. The pulley assembly of claim 9 in which the ratio r≃3.

11. The pulley assembly of claim 1 in which the bollard provides a solid and immovable interconnection between the plates.

12. The pulley assembly of claim 1 in which the bollard is releasably connected to one or both of the plates.

13. An installation for moving objects comprising a main line secured to two spaced-apart anchors; a trolley supported by and capable of moving along the main line; a control line connected to the trolley, whereby tension on the control line can draw the trolley along the main line; and a pulley assembly according to claim 1; wherein the pulley assembly is connected to an anchor by a line that is passed about the bollard, and main line and/or the control line extends over one of the sheaves of the pulley assembly.

14. The installation of claim 13 further including a lifting line that is secured to a load to be moved, and that extends over a sheave of the trolley and a sheave of the pulley assembly, and has a free end portion that extends from the pulley assembly.

15. The installation of claim 13 further including a securing line, a length of which passes in a bight around the bollard and which is secured to an anchorage.

16. The installation of claim 13 in which the pulley assembly includes a cross-hole that extends generally perpendicular to the median plane through the plates and through the bollard and which further includes a secondary securing line that passes through the cross-hole and is secured to an anchorage.

17. An installation of claim 13 that includes a securing line that is fixed to the anchorage at two fixed points, and extends between the fixed points through the cross-hole, around the bollard and around the anchorage.
